(19) United States
(12) Patent Application Publication
(10) Pub. No.: US 2017/0304916 A1
(43) Pub. Date: Oct. 26, 2017

(54) DEMOLITION ROTARY SAW BLADE

(71) Applicants: Kenneth Fred Collister, Rochester, MI (US); Brenden Jonathan Jones, Rochester Hills, MI (US)

(72) Inventors: Kenneth Fred Collister, Rochester, MI (US); Brenden Jonathan Jones, Rochester Hills, MI (US)

(21) Appl. No.: 15/648,592

(22) Filed: Jul. 13, 2017

Related U.S. Application Data
(63) Continuation-in-part of application No. 14/829,691, filed on Aug. 19, 2015.
(60) Provisional application No. 62/045,059, filed on Sep. 3, 2014.

(51) Int. Cl. B23D 61/02

(52) U.S. Cl. CPC B23D 61/025; B23D 61/028

(57) ABSTRACT

A circular saw blade for cutting construction materials. The rotary blade contains a central hole from which the central body extends. Peaked fingers are separated by gullets. The peaked fingers contain tooth supports which hold extended carbide teeth. The blade can be used to cut abrasive and sticky constructions materials with a circular saw.

### CROSS-REFERENCE TO RELATED APPLICATION

This application is a continuation-in-part of U.S. application Ser. No. 14/829,691, filed on Aug. 19, 2015, which claims priority to and all the benefits of U.S. Provisional Patent Application Ser. No. 62/045,059, filed on Sep. 3, 2014, the entire contents of which are expressly incorporated herein by reference.

### TECHNICAL FIELD

The subject invention relates to the construction trades, and more particularly to circular saw blades for cutting roofing materials.

### BACKGROUND OF THE INVENTION

Contractors routinely use circular saw blades for construction demolition. Cutting varied construction materials is difficult because carbide teeth chip off or become dull, and gullets clog with construction materials, increasing friction and blade temperature, which can cause the blade to warp or lead to fires. These problems cause saws to wear out prematurely and result in the loss of work productivity. The present inventors have advanced the technology in this area with saw blades that cut through difficult materials such as roofing materials. This disclosure presents yet more improvements.

### SUMMARY OF THE INVENTION

According to one aspect of the invention, there is a rotary saw blade for cutting construction materials. The blade includes a central body, an arbor hole defined in the central body, a plurality of peaked fingers extending from the central body, a carbide tooth disposed on the end of each finger, a buttress disposed at the base of each finger as it extends away from the central body, and a removable piece having a non-circular-shape disposed around the arbor hole wherein the removable piece can be removed to form a non-circular arbor hole to allow the blade to fit over a non-circular arbor for preventing rotation of the blade relative to the arbor. The invention could also include a pattern formed in the blade around the removable piece so that the piece can snap out easily with the aid of a simple tool such as a screw driver. The invention could also further include support zones disposed as part of the blade around the arbor hole between fingers and adjacent the removable piece to provide extra structural support for the fingers.

The invention makes it possible to cut various construction materials with a circular saw including plaster and lathe, asphalt shingles, tar and gravel, ice shield, cap sheet, and metal. Contractors and homeowners will benefit from changing blades less often, and enjoying increased life of the circular saw.

### FIGURES IN THE DRAWINGS

The present invention will now be described, by way of example, with reference to the accompanying drawings, in which:

FIG. 1 is a perspective view of a first preferred embodiment; and

FIG. 2 is a perspective view of a second preferred embodiment.

### DETAILED DESCRIPTION

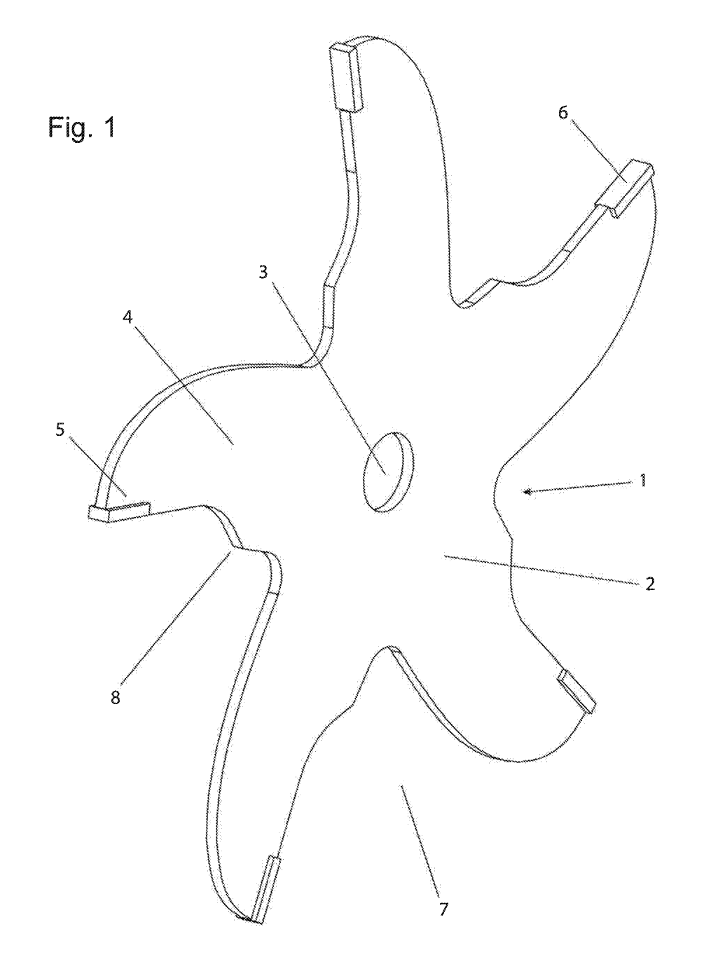

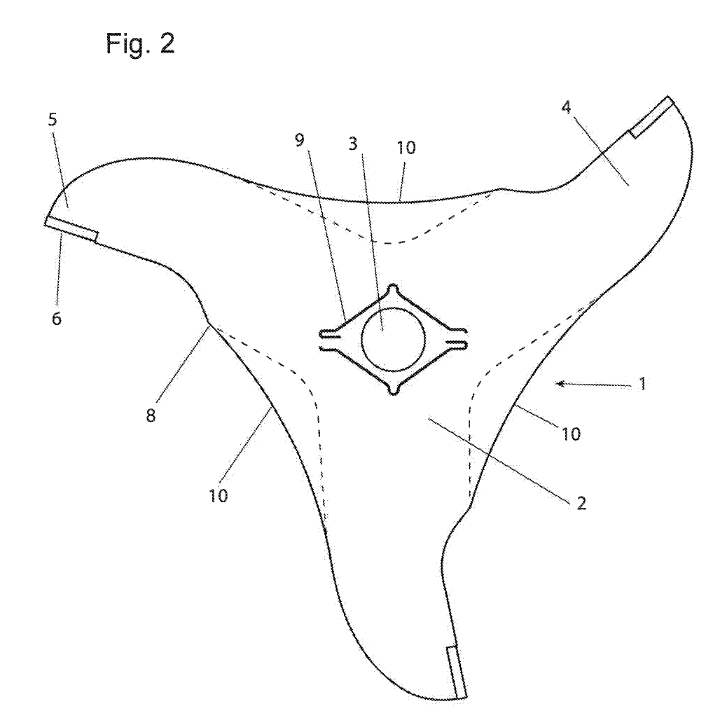

The present invention will now be described, by way of example, with reference to the accompanying drawings in which a rotary blade assembly is generally shown at i in FIGS. 1 and 2.

According to a broad conception of the invention, there is a rotary blade 1for cutting construction materials. The rotary blade 1 comprises, among other things, a central body 2. The blade also comprises a central hole 3, from which the peaked fingers 4 extend. Within the peaked fingers 4, tooth supports 5 contain extended carbide teeth 6 that are wider than the central body 2. These wide carbide teeth tend to keep the cutting materials away from the central body, which greatly decreases the amount of material that adheres to the blade. This, in turn, increases the effectiveness of the blade. The tooth supports 5 must maintain a thickness that hold extended carbide teeth 6 large enough to cut thick construction materials while still fitting on to the arbor of a 7¼ inch circular saw. The combination of the thick central body 2 and oversized carbide teeth 6 creates an extra large brazing area to securely hold carbide teeth 6 and reduce the risk of teeth chipping off.

Another aspect to the invention are gullets 7 which separate peaked fingers 4. One benefit to deep gullets 7 is that the central body 1 is not in contact with the cutting material, which further reduces friction. Another benefit of the deep gullets 7 is that they are so deep that they will less likely clog with cutting material because the open space allows the trailing peaked fingers 4 to unload cutting materials as the blade rotates. Decreased friction and elimination of clogging extends the life of the circular saw motor.

Another aspect to the invention is the buttressed finger base 8 having a buttress. One benefit to the buttressed finger base is that it increases the strength of the peaked fingers 4. The buttress helps support the finger during rotation through tough roofing materials.

Another aspect of the invention relating to this is the precise hardness of the steel central body 2, which is Number 45. A blade must be afforded a minimum level of steel hardness that will not bend or break when cutting through certain construction materials including, but not limited to, tar and gravel.

Another aspect of the invention is the non-stick coating which covers the entire rotary blade 1. One benefit of the non-stick coating is that it decreases build-up of construction materials including, but not limited to tar. An additional benefit of the coating is that it softens the sharp edges of the carbide teeth 6 which reduces the risk of injury when installing or removing the blade from the circular saw.

FIG. 2 shows an embodiment of the blade 1 having three fingers 4. The blade 1 also has central body 2, the arbor hole 3, the peaked fingers 4, tooth supports 5, carbide teeth 6, and buttressed finger base 8. Additionally, the blade of this embodiment has the irregularly-shaped (non-circular) cut out 9 around the arbor hole. The cut-out is formed by cutting a desirable pattern into or through the blade so that a piece—e.g. diamond-shaped—can snap out easily with the aid of a simple tool such as a screw driver. This allows the user to snap out the piece if there is a similarly-shaped arbor feature on the saw to prevent slipping (i.e. rotating) of the saw blade during use.

The blade 1 is also formed with support zones 10 to provide extra structural support for the fingers 4 to prevent them from possibly breaking—especially if the user opts to remove the diamond-shaped piece. Dotted lines have been added to FIG. 2 to more clearly indicate where material has been added or included (or at least not removed during formation of the blade) to create the support zones between the fingers. This added material also provides strength and support to the fingers to withstand vibrations or deflections off concrete and re-bar materials that may be in roof decks.

The invention has been described in an illustrative manner, and it is to be understood that the terminology that has been used is intended to be in the manner of words of description rather than words of limitation.

Obviously, many modifications and variations are possible in light of the above teachings. It is therefore to be understood that within the scope of the appended claims wherein reference numerals are merely for convenience and are not to be in any way limiting, the invention may be practiced otherwise than as specifically described.

We claim:

1. A rotary circular saw blade for the cutting of construction materials comprising:
a central body,
an arbor hole defined in the central body,
a plurality of peaked fingers extending from the central body,
a carbide tooth disposed on the end of each finger,
a buttress disposed at the base of each finger as it extends away from the central body, and
a removable piece having a non-circular-shape disposed around the arbor hole wherein the removable piece can be removed to form a non-circular arbor hole to allow the blade to fit over a non-circular arbor for preventing rotation of the blade relative to the arbor.

2. The saw blade of claim 1 wherein the blade includes a pattern formed in the blade around the removable piece so that the piece can snap out easily with the aid of a simple tool such as a screw driver.

3. The saw blade of claim 2 wherein the blade includes support zones disposed around the arbor hole between fingers and adjacent the removable piece to provide extra structural support for the fingers.

4. The saw blade of claim 3 wherein the blade includes steel hardened to number 45.

5. The saw blade of claim 3 wherein the blade includes steel having a thickness between 80 thousandths and 105 thousandths of an inch.

6. The saw blade of claim 3 wherein the carbide teeth extend beyond each side of the central body by at least 45 thousandths of an inch.

7. The saw blade of claim 1 further including a non-stick coating to prevent cutting material from sticking to the central body.

8. The saw blade of claim 3 wherein the support zones include extra material extending between adjacent fingers and adjacent each buttress.
